(19) United States
(12) Patent Application Publication
(10) Pub. No.: US 2023/0198894 A1
(43) Pub. Date: Jun. 22, 2023

(54) COMMUNICATION SYSTEM, COMMUNICATION PATH MONITORING METHOD, COMMUNICATION DEVICE, AND PROGRAM

(71) Applicant: NIPPON TELEGRAPH AND TELEPHONE CORPORATION, Tokyo (JP)

(72) Inventors: Ken IIDA, Musashino-shi, Tokyo (JP); Tomoya KOSUGI, Musashino-shi, Tokyo (JP)

(73) Assignee: NIPPON TELEGRAPH AND TELEPHONE CORPORATION, Tokyo (JP)

(21) Appl. No.: 17/926,839

(22) PCT Filed: May 26, 2020
(86) PCT No.: PCT/JP2020/020694

§ 371 Date: Nov. 21, 2022

(51) Int. Cl. H04L 45/00; H04L 41/0654

(52) U.S. Cl. CPC H04L 45/22; H04L 41/0654

(57) ABSTRACT

An object of the present disclosure is to provide a communication system capable of constantly performing monitoring in conjunction with client signals regardless of switching due to a failure in a network.

The present disclosure provides a communication system where a plurality of communication apparatuses are connected to a zeroth communication apparatus and that is capable of switching a path connecting a first communication apparatus among the plurality of communication apparatuses and the zeroth communication apparatus and a path connecting a second communication apparatus among the plurality of communication apparatuses and the zeroth communication apparatus, in which the first communication apparatus periodically transmits a monitoring signal to the zeroth communication apparatus, the zeroth communication apparatus transfers the monitoring signal from the first communication apparatus to the second communication apparatus, the second communication apparatus enables a monitoring signal transmitting function and starts to transmit the monitoring signal to the zeroth communication apparatus when non-reception of the monitoring signal from the first communication apparatus continues a predefined number of times, the zeroth communication apparatus transfers the monitoring signal from the second communication apparatus to the first communication apparatus, and the first communication apparatus disables the monitoring signal transmitting function when the monitoring signal from the second communication apparatus is received.

### TECHNICAL FIELD

This relates to a communication scheme and a communication system capable of constantly monitoring a communication path through which a client signal flows, by switching a monitoring endpoint in conjunction with switching of a communication path due to occurrence of a failure in a communication network providing redundancy in an active-standby configuration with a plurality of communication apparatuses for a single communication apparatus.

### BACKGROUND ART

As a technique using monitoring signals between communication apparatuses, the Ethernet operation administration and maintenance (OAM) standardized as Y. 1731 by the International Telecommunication Union Telecommunication Standardization Sector (ITU-T) and defined as IEEE 802. lag or the like by the Institute of Electrical and Electronics Engineers (IEEE) 802 is exemplified. An entity called a maintenance entity group (MEG) end point (MEP) has been introduced in the Ethernet OAM.

The MEP is a monitoring endpoint (endpoint) for generating and terminating an Ethernet OAM frame. It is possible to perform continuous checking of connectivity, a notification of failure information, and the like by exchanging MEG-level OAM frames set in advance between MEPs.

In monitoring between communication apparatuses in a network, checking of connectivity and a notification of failure information are performed by transmitting and receiving OAM frames between apparatus monitoring endpoints using the technique of the Ethernet OAM. On the other hand, a redundancy configuration of communication apparatuses is employed to enhance network availability in a network of a communication service provider.

In a case in which a plurality of communication apparatuses are connected as a redundancy configuration to a single communication apparatus, it is not possible to ascertain which of an active system and an standby system a client signal is flowing through although it is possible to check mutual communication between the communication apparatuses according to the Ethernet OAM. Therefore, there is a problem that it is not possible to manage the communication path unless a maintenance person understands the active system based on design information and collates what he/she understands with mutual communication information of the Ethernet OAM.

### CITATION LIST

### Non Patent Literature

NPL 1: TTC, JT-Y1731 “OAM Functions and mechanisms for Ethernet based Networks”

### SUMMARY OF THE INVENTION

### Technical Problem

The present disclosure is made in order to solve the aforementioned problem, and an object thereof is to provide a communication system capable of constantly performing monitoring in conjunction with client signals regardless of switching due to a failure in the aforementioned network.

### Means for Solving the Problem

In the present disclosure, a multicast monitoring signal is transmitted at a monitoring endpoint set in each apparatus. A communication apparatus in an standby system receives a multicast monitoring signal transmitted from a communication apparatus in an active system (a system through which a client signal flows) via a single communication apparatus. The communication apparatus in the standby system detects disconnection of the monitoring signal from the active system when a failure occurs on the active system side, and then the communication apparatus in the standby system transmits the multicast monitoring signal. This enables checking of mutual communication between the apparatuses, and the communication path of the client signal and the path through which the monitoring signal flows (the communication apparatus that transmits the monitoring signal) are the same, and it is thus possible for the maintenance person to manage the communication path only from the monitoring signal.

Specifically, a communication system and a communication path monitoring method according to the present disclosure, there is provided a communication system where a plurality of communication apparatuses are connected to a zeroth communication apparatus and that is capable of switching a path connecting a first communication apparatus among the plurality of communication apparatuses and the zeroth communication apparatus and a path connecting a second communication apparatus among the plurality of communication apparatuses and the zeroth communication apparatus, in which the first communication apparatus periodically transmits a monitoring signal to the zeroth communication apparatus, the zeroth communication apparatus transfers the monitoring signal from the first communication apparatus to the second communication apparatus, the second communication apparatus enables transmitting a monitoring signal and starts to transmit the monitoring signal to the zeroth communication apparatus when the second communication apparatus does not receive the monitoring signal from the first communication apparatus continuously for a predefined number of times, the zeroth communication apparatus transfers the monitoring signal from the second communication apparatus to the first communication apparatus, and the first communication apparatus disables transmitting the monitoring signal when the first communication apparatus receives the monitoring signal from the second communication apparatus.

Specifically, a communication apparatus according to the present disclosure is a communication apparatus included in a communication system where a plurality of communication apparatuses are connected to a zeroth communication apparatus and that is capable of switching a path connecting a first communication apparatus among the plurality of communication apparatuses and the zeroth communication apparatus and a path connecting a second communication apparatus among the plurality of communication apparatuses and the zeroth communication apparatus, in which a monitoring signal is periodically transmitted to the zeroth communication apparatus, and when a monitoring signal is received from the second communication apparatus, transmitting the monitoring signal is disabled.

Specifically, a communication apparatus according to the present disclosure is a communication apparatus included in a communication system where a plurality of communication apparatuses are connected to a zeroth communication apparatus and that is capable of switching a path connecting a first communication apparatus among the plurality of communication apparatuses and the zeroth communication apparatus and a path connecting a second communication apparatus among the plurality of communication apparatuses and the zeroth communication apparatus, when a monitoring signal from the first communication apparatus is not received continuously for a predefined number of times, transmitting a monitoring signal is enabled, and transmission of the monitoring signal to the zeroth communication apparatus is started.

Specifically, a program according to the present disclosure is a program for causing a computer to be implemented as each unit included in the communication apparatus according to the present disclosure and a program that causes the computer to execute each step included in a communication path monitoring method executed by the communication apparatus according to the present disclosure.

### Effects of the Invention

According to the present disclosure, because setting is performed such that monitoring of an active system is performed, and monitoring is switched to an standby system at the time of a failure, the communication path and the path for the monitoring signal are always the same path, and it is thus possible to provide a communication system with no need to understand the communication path.

### BRIEF DESCRIPTION OF DRAWINGS

FIG. 1 illustrates an outline of a system configuration in the related art.

FIG. 2 illustrates an example of operations in the related art in a case in which a failure has occurred.

FIG. 3 illustrates an outline of a system configuration according to the present disclosure.

FIG. 4 illustrates an example of a system configuration according to a first embodiment.

FIG. 5 illustrates an example of a system configuration according to a second embodiment.

FIG. 6 illustrates an example of a system configuration according to a third embodiment.

FIG. 7 illustrates an example of a flow of a downlink signal according to the third embodiment.

FIG. 8 illustrates an example of a flow of an uplink signal according to the third embodiment.

FIG. 9 illustrates an example of a system configuration according to a fourth embodiment.

FIG. 10 illustrates an example of a reference table according to the fourth embodiment.

### DESCRIPTION OF EMBODIMENTS

Hereinafter, embodiments of the present disclosure will be described in detail with reference to the drawings. Further, the present disclosure is not limited to the embodiments described below. These examples of the embodiments are merely examples, and the present disclosure can be implemented in forms in which various modifications and improvements are added based on knowledge of those skilled in the art. Constituent elements with the same reference signs in the description and the drawings are assumed to be the same constituent elements.

### Related Art

In communication networks of communication service provides, redundancy is typically configured by installing a plurality of apparatuses in order to enhance availability of the networks.

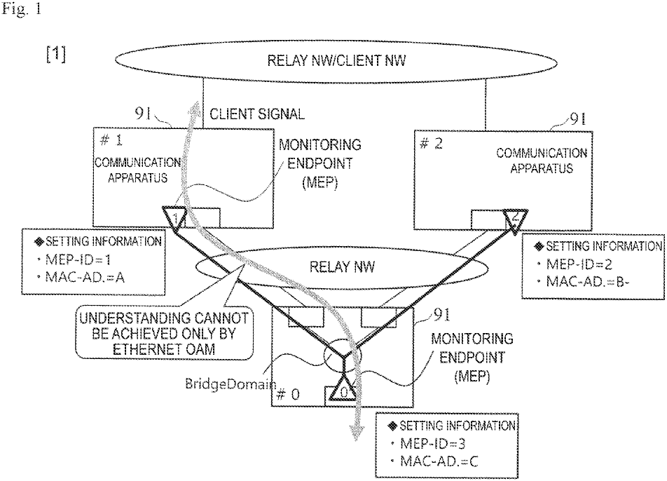

As illustrated in FIG. 1, for example, a communication apparatus (91#1) and a communication apparatus (91#2) are connected to a single communication apparatus (91#0). An active-standby configuration in which communication is performed between the single communication apparatus (91#0) and the communication apparatus (91#1) (active system) when no failure occurs and signals that are being communicated between the communication apparatus (91#0) and the communication apparatus (91#1) are switched to the communication apparatus (91#0) and the communication apparatus (91#2) (standby system) when a failure occurs in an apparatus or a transmission medium between the communication apparatus (#0) and the communication apparatus (#1) is employed.

When an Ethernet OAM is applied in the communication network with this configuration, monitoring of the paths is performed by disposing monitoring endpoints at the communication apparatus (91#1) and the communication apparatus (91#0) respectively and transmitting and receiving monitoring signals between the monitoring endpoints. In order to secure normal switching at the time of a failure, disposition of monitoring endpoints at the communication apparatus (91#2) and the communication apparatus (91#0) respectively is performed.

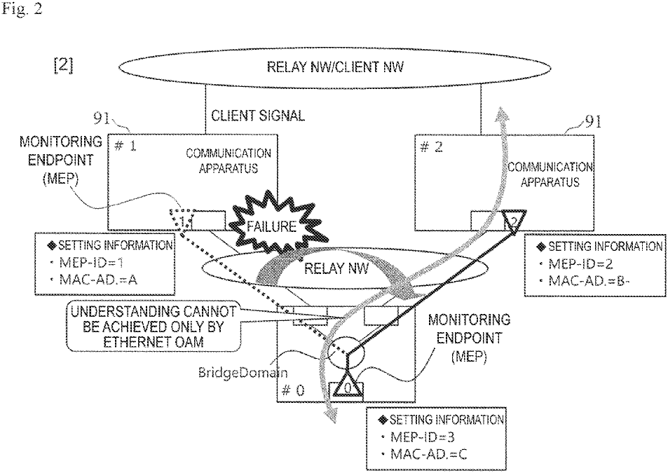

Communication service providers can check connectivity of the active system and the standby system with the Ethernet OAM in the aforementioned network. However, it is difficult to check whether client signals are appropriately flowing merely with the Ethernet OAM as illustrated in FIG. 2. Although it is possible to check mutual communication between apparatuses merely with the Ethernet OAM, it is necessary, as a carrier, to manage which of the active system and the standby system the client signals are flowing as a carrier. According to the related art, it is not possible to perform the management unless the active system is understood based on design information and the understood content is collated with mutual communication checking information of the Ethernet OAM, and operations are thus required. In a case in which no failure has occurred, for example, it is also necessary to understand the Ethernet OAM and the communication paths. Also, when switching from the active system to the standby system has occurred for some reason such as a failure, it is necessary to check whether the client signals are flowing through the standby system in addition to the Ethernet OAM.

### Summary of the Invention

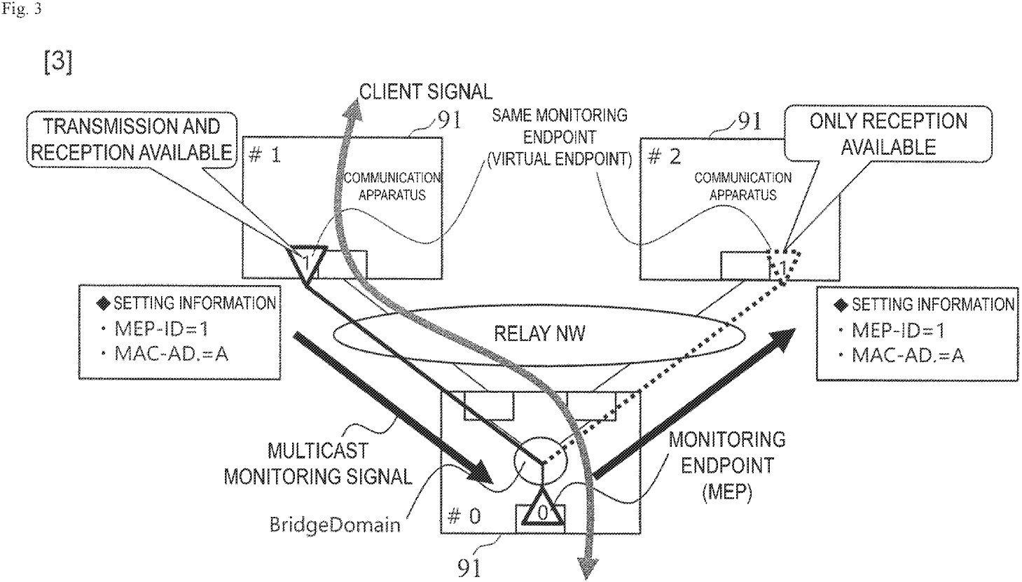

An overview of the present disclosure will be described with reference to FIG. 3. FIG. 3 illustrates an overview of a system configuration according to the present disclosure. In a plurality of communication apparatuses 91 that take apparatus redundancy, the same monitoring endpoint (virtual endpoint) is set for a communication apparatus (91#1) and a communication apparatus (91#2) in advance. At this time, the monitoring endpoint of the communication apparatus (91#1) connected to a path on an active side is adapted to be able to transmit and receive monitoring signals, and the monitoring endpoint of the communication apparatus (91#2) connected to a path of an standby system is adapted to be able to perform only reception.

The communication apparatus (91#0) receives a monitoring signal of the communication apparatus (91#1) and transmits a multicast monitoring signal. The multicast monitoring signal is transmitted from the monitoring endpoint of the communication apparatus (91#1), and reception determination is performed at the monitoring endpoint of the communication apparatus (91#2). In a case in which it is determined that the monitoring signal has not been received at the monitoring endpoint of the communication apparatus (91#2), the communication apparatus (91#2) is adapted to be able to transmit and receive a monitoring signal. The communication apparatus (91#1) that has received the monitoring signal from the monitoring endpoint of the communication apparatus (91#2) that has transitioned to the active system is adapted to perform only reception.

### First Embodiment Example

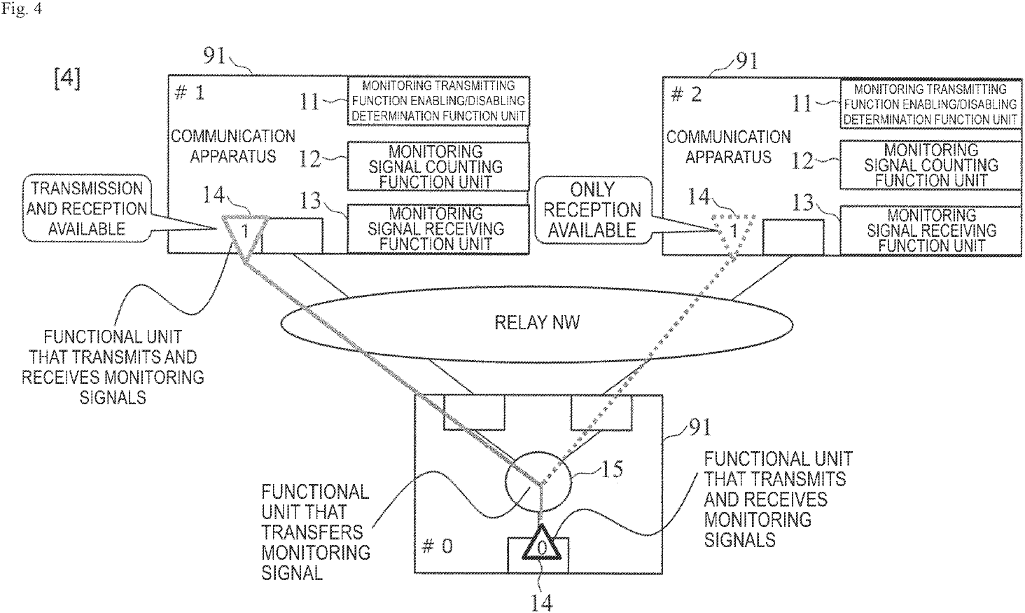

FIG. 4 illustrates an example of a system configuration according to the present embodiment. A system according to the present embodiment has a basic configuration of the present disclosure. Specifically, the system according to the present embodiment includes three communication apparatuses 91. Connection is established between 91#1 and 91#0 and between 91#2 and 91#0, respectively. However, it is not necessary for these apparatuses to be connected directly to each other.

The communication apparatus 91#1 includes a functional unit 14 that transmits and receives monitoring signals, a functional unit that extracts a monitoring signal among signals received from the communication apparatus 91#2 (monitoring signal receiving function unit 13), a functional unit that counts received monitoring signals (monitoring signal counting function unit 12), and a functional unit that enables and disables a transmitting function of the functional unit that transmits and receives monitoring signals based on the count result (monitoring transmitting function enabling/disabling determination function unit 11). The functional unit 14 functions as a monitoring endpoint and a virtual monitoring endpoint and is, for example, a maintenance end point (MEP) of Y.1731.

The communication apparatus 91#2 includes a functional unit 14 that transmits and receives monitoring signals, a functional unit that extracts a monitoring signal among signals received from the communication apparatus 91#1 (monitoring signal receiving function unit 13), a functional unit that counts received monitoring signals (monitoring signal counting function unit 12), and a functional unit that enables and disables a transmitting function of the functional unit that transmits and receives monitoring signals based on the count result (monitoring transmitting function enabling/disabling determination function unit 11).

The communication apparatus 91#0 includes a functional unit 15 that transfers monitoring signal and a functional unit 14 that transmits and receives monitoring signals.

A flow of signals in the present embodiment will be described with reference to FIG. 4. Step S101: The communication apparatus 91#2 sets an identifier of the functional unit 14 that transmits and receives monitoring signals to the same value as a monitoring identifier of a monitoring endpoint set in the communication apparatus 91#1 and disables only the transmitting function.

Step S102: The communication apparatus 91#1 transmits, at an interval of N seconds, a multicast monitoring signal with an identifier (the identifier of the monitoring endpoint) set in advance in the functional unit that transmits and receives monitoring signals (the reference sign 14 illustrated in FIG. 4).

The communication apparatus 91#0 receives the multicast monitoring signal and transfers the multicast monitoring signal to the communication apparatus 91#2.

The communication apparatus 91#2 receives the multicast monitoring signal transmitted from the communication apparatus 91#0, the monitoring signal receiving function unit 13 extracts the multicast monitoring signal, the monitoring signal counting function unit 12 calculates an arrival time interval of the multicast monitoring signal, and determination of non-reception is made in a case in which the monitoring transmitting function enabling/disabling determination function unit 11 determines that the multicast monitoring signal has not been received M number of times straight at the interval of N seconds. In a case in which determination of non-reception is made, the communication apparatus 91#2 enables the transmitting function of the functional unit that transmits and receives multicast monitoring signals (the reference sign 14 illustrated in FIG. 4). However, M and N are predefined numbers, and an any natural number that is equal to or greater than two can be employed as M.

Step S103: The communication apparatus 91#2 transmits the multicast monitoring signal at the interval of N seconds.

The communication apparatus 91#0 receives the multicast monitoring signal and transfers the multicast monitoring signal to the communication apparatus 91#1.

The communication apparatus 91#1 receives the multicast monitoring signal transmitted from the communication apparatus 91#0, the monitoring signal receiving function unit 13 extracts the multicast monitoring signal, the monitoring signal counting function unit 12 calculates an arrival time interval of the multicast monitoring signal, and determination of reception is made in a case in which the monitoring transmitting function enabling/disabling determination function unit 11 determines that the multicast monitoring signal has been received M times straight at the interval of N seconds. In the case in which determination of reception is made, the transmitting function of the functional unit that transmits and receives multicast monitoring signals (the reference sign 14 illustrated in FIG. 4) is disabled.

### Second Embodiment Example

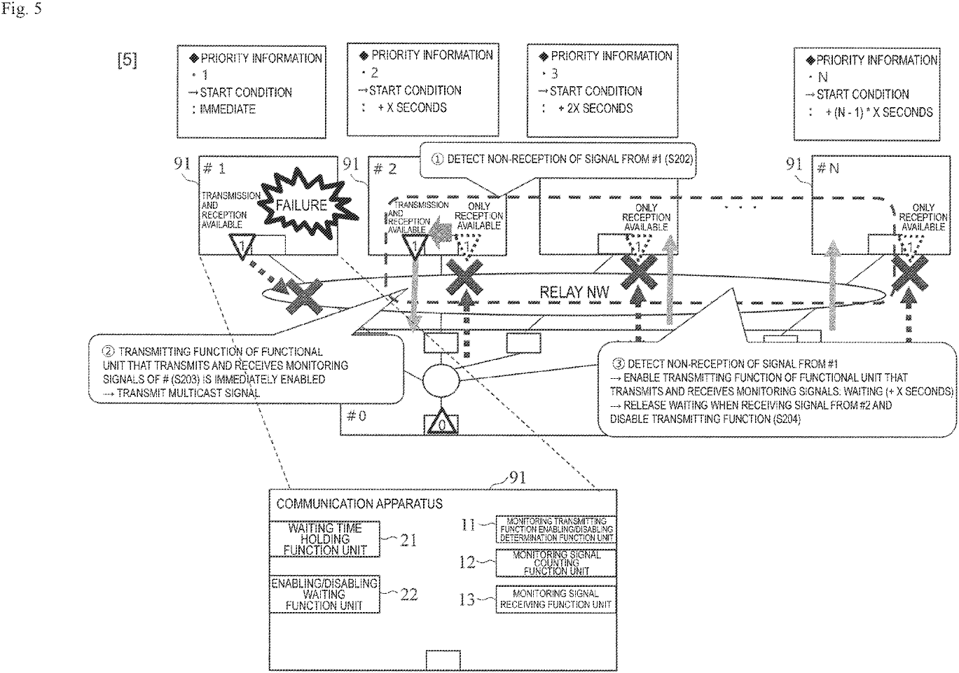

FIG. 5 illustrates an example of a system configuration according to the present embodiment. The system according to the present embodiment includes a plurality of redundant configurations of communication apparatuses. Specifically, the system according to the present embodiment includes N communication apparatuses. Connection is established between 91#1 and 91#0, between 91#2 and 91#0, ..., and between 91#N and 91#0, respectively. However, it is not necessary for these apparatuses to be connected directly to each other.

The communication apparatus 91#1 (91#2 to 91#N are also the same as each) includes the functional units included in that in the first embodiment example, a functional unit that holds a waiting time based on relative priority held by each of the communication apparatuses 91#1 to 91#N (waiting time holding function unit 21), and a functional unit that delays enabling/disabling of the transmitting function of the functional unit that transmits and receives monitoring signals (the reference sign 14 illustrated in FIG. 4) by the waiting time (enabling/disabling waiting function unit 22).

The communication apparatus 91#0 has the functional units included in the first embodiment example.

A flow of signals in the present embodiment will be described with reference to FIG. 5. Step S201: The communication apparatus 91#2 (91#3 to 91#N are also the same as each) sets an identifier of the functional unit that transmits and receives monitoring signals (the reference sign 14 illustrated in FIG. 4) to the same value as the monitoring identifier of the monitoring endpoint set in the communication apparatus 91#1 and disables the functional unit that transmits and receives monitoring signals.

Step S202: The communication apparatus 91#1 transmits, at an interval of N seconds, a multicast monitoring signal with an identifier (an identifier of the monitoring endpoint) set in advance in the functional unit that transmits and receives monitoring signals (the reference sign 14 illustrated in FIG. 4).

The communication apparatus 91#0 receives the multicast monitoring signal and transfers the multicast monitoring signal to all the communication apparatuses 91#2 to 91#N.

The communication apparatus 91#2 (91#3 to 91#N are also the same as each) receives the multicast monitoring signal transmitted from the communication apparatus 91#0, the monitoring signal receiving function unit 13 extracts the multicast monitoring signal, and the monitoring signal counting function unit 12 calculates an arrival time interval of the multicast monitoring signal. The communication apparatus 91#2 makes determination of non-reception in a case in which the monitoring transmitting function enabling/disabling determination function unit 11 determines that the multicast monitoring signal has not been received M times straight at the interval of N seconds. In the case in which the determination of non-reception is made, the transmitting function of the functional unit that transmits and receives multicast monitoring signals (the reference sign 14 illustrated in FIG. 4) is enabled. At this time, a specific time is waited until the function is enabled in accordance with the waiting time held in advance.

Step S203: The communication apparatus 91#2 transmits the multicast monitoring signal at the interval of N seconds.

The communication apparatus 91#0 receives the multicast monitoring signal and transfers the multicast monitoring signal to the communication apparatuses 91#1 to 91#N except for the communication apparatus 91#2.

Step S204: The communication apparatus 91#1 receives the multicast monitoring signal transmitted from the communication apparatus #0, the monitoring signal receiving function unit 13 extracts the multicast monitoring signal, and the monitoring signal counting function unit 12 calculates an arrival time interval of the multicast monitoring signal. The communication apparatus 91#1 makes determination of reception in a case in which the monitoring transmitting function enabling/disabling determination function unit 11 determines that the multicast monitoring signal has been received M times straight at the interval of N seconds. In the case in which determination of reception is made, the transmitting function of the functional unit that transmits and receives multicast monitoring signals (the reference sign 14 illustrated in FIG. 4) is disabled.

The communication apparatus 91#3 (91#4 to 91#N are also the same as each) receives the multicast monitoring signal transmitted from the communication apparatus 91#2 during a certain waiting time, the monitoring signal receiving function unit 13 extracts the multicast monitoring signal, and the monitoring signal counting function unit 12 calculates an arrival time interval of the multicast monitoring signal. The communication apparatus 91#3 makes determination of reception in a case in which the monitoring transmitting function enabling/disabling determination function unit 11 determines that the multicast monitoring signal has been received M times straight at the interval of N seconds. In the case in which the determination of reception is made, the functional unit that transmits and receives multicast monitoring signals (the reference sign 14 illustrated in FIG. 4) is disabled.

### Third Embodiment Example

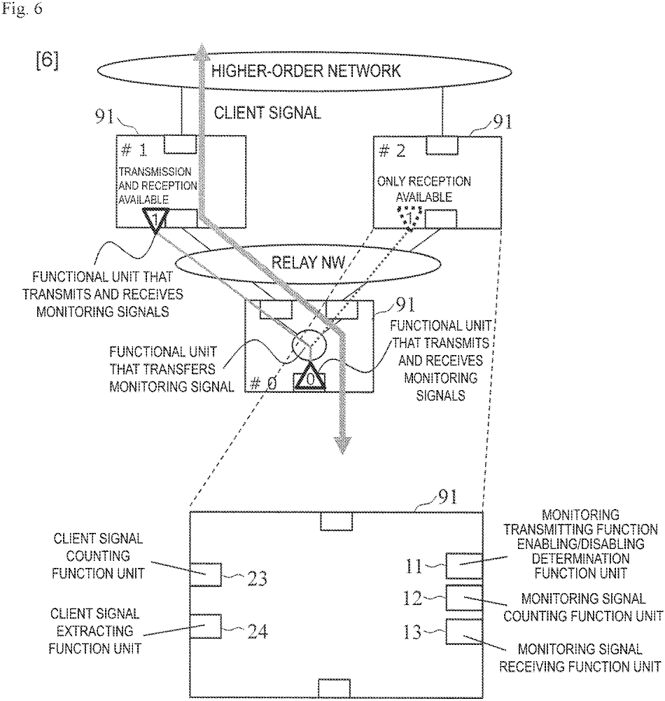

FIG. 6 illustrates an example of a system configuration according to the present embodiment. The system according to the present embodiment includes a configuration of switching monitoring in conjunction with client signals. Specifically, the system according to the present embodiment includes three communication apparatuses. Connection is established between 91#1 and 91#0 and between 91#2 and 91#0, respectively. However, it is not necessary for these apparatuses to be connected directly to each other.

The communication apparatuses 91#1 and 91#2 are connected to higher-order networks in which client signals flow.

The communication apparatus 91#1 includes the functional units included in the first embodiment example, a functional unit that extracts client signals other than monitoring signals among the signals received from the higher-order network and transmitted to the communication apparatus 91#0 (client signal extracting function unit 24) and a functional unit that counts the client signals (client signal counting function unit 23).

The communication apparatus 91#2 includes the functional units included in the first embodiment example, a functional unit that extracts client signals other than monitoring signals among the signals received from the higher-order network and transmitted to the communication apparatus 91#0 (client signal extracting function unit 24) and a functional unit that counts the client signals (client signal counting function unit 23).

The communication apparatus 91#0 has the functional units included in the first embodiment example.

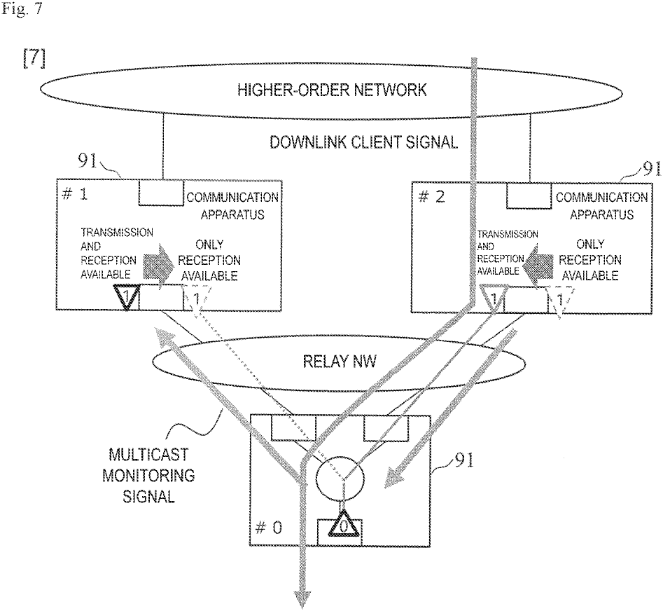

A flow of downlink signals according to the present embodiment will be described with reference to FIG. 7.

Step S311: The communication apparatus 91#2 sets an identifier of the functional unit that transmits and receives monitoring signals (the reference sign 14 illustrated in FIG. 4) to the same value as the monitoring identifier of the monitoring endpoint set in the communication apparatus 91#1 and disables the functional unit that transmits and receives monitoring signals.

Step S312: The communication apparatus 91#2 receives a downlink client signal flowing from the higher-order network, the client signal extracting function unit 24 extracts the downlink client signal, the client signal counting function unit 23 calculates an arrival time interval of the downlink client signal, and determination of reception is made in a case in which the monitoring transmitting function enabling/disabling determination function unit 11 determines that the downlink client signal has been received L times straight. In the case in which the determination of reception is made, the transmitting function of the functional unit that transmits and receives multicast monitoring signals (the reference sign 14 illustrated in FIG. 4) is enabled. Here, L is a predefined number, and an any natural number that is equal to or greater than one can be employed. The same applies to the following description.

Step S313: The communication apparatus 91#2 transmits the multicast monitoring signal at the interval of N seconds.

The communication apparatus 91#0 receives the multicast monitoring signal and transfers the multicast monitoring signal to the communication apparatus 91#1.

The communication apparatus 91#1 receives the multicast monitoring signal transmitted from the communication apparatus 91#2, the monitoring signal receiving function unit 13 extracts the multicast monitoring signal, the monitoring signal counting function unit 12 calculates an arrival time interval of the multicast monitoring signal, and determination of reception is made in a case in which the monitoring transmitting function enabling/disabling determination function unit 11 determines that the multicast monitoring signal has been received M times straight at the interval of N seconds. In the case in which determination of reception is made, the transmitting function of the functional unit that transmits and receives multicast monitoring signals (the reference sign 14 illustrated in FIG. 4) is disabled.

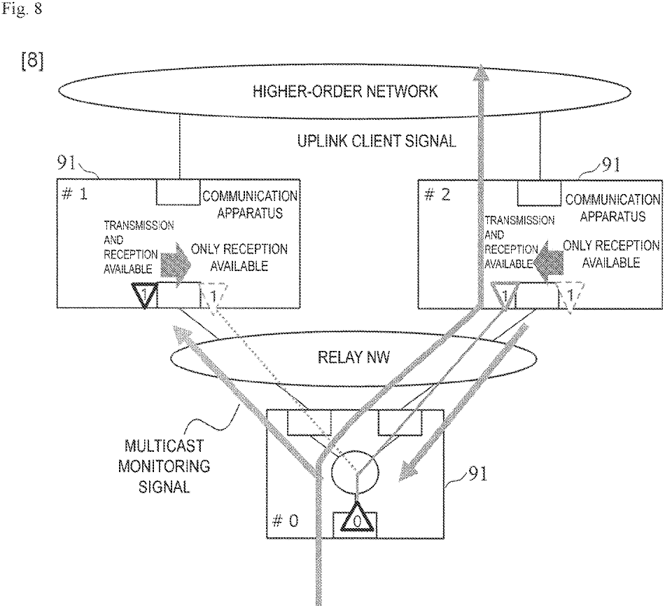

A flow of an uplink signal according to the present embodiment will be described with reference to FIG. 8.

Step S321: The communication apparatus 91#2 sets an identifier of the functional unit that transmits and receives monitoring signals (the reference sign 14 illustrated in FIG. 4) to the same value as the monitoring identifier of the monitoring endpoint set in the communication apparatus 91#1 and disables the functional unit that transmits and receives monitoring signals.

Step S322: The communication apparatus 91#2 receives the uplink client signal flowing from the communication apparatus 91#0, the client signal extracting function unit 24 extracts the uplink client signal, the client signal counting function unit 23 calculates an arrival time interval of the uplink client signal, and determination of reception is made in a case in which the monitoring transmitting function enabling/disabling determination function unit 11 determines that the uplink client signal has been received L times straight. In the case in which the determination of reception is made, the transmitting function of the functional unit that transmits and receives multicast monitoring signals (the reference sign 14 illustrated in FIG. 4) is enabled.

Step S323: The communication apparatus 91#2 transmits the multicast monitoring signal at the interval of N seconds.

The communication apparatus 91#0 receives the multicast monitoring signal and transfers the multicast monitoring signal to the communication apparatus 91#1.

The communication apparatus 91#1 receives the multicast monitoring signal transmitted from the communication apparatus 91#0, the monitoring signal receiving function unit 13 extracts the multicast monitoring signal, the monitoring signal counting function unit 12 calculates an arrival time interval of the multicast monitoring signal, and determination of reception is made in a case in which the monitoring transmitting function enabling/disabling determination function unit 11 determines that the multicast monitoring signal has been received M times straight at the interval of N seconds. In the case in which determination of reception is made, the transmitting function of the functional unit that transmits and receives multicast monitoring signals (the reference sign 14 illustrated in FIG. 4) is disabled.

### Fourth Embodiment Example

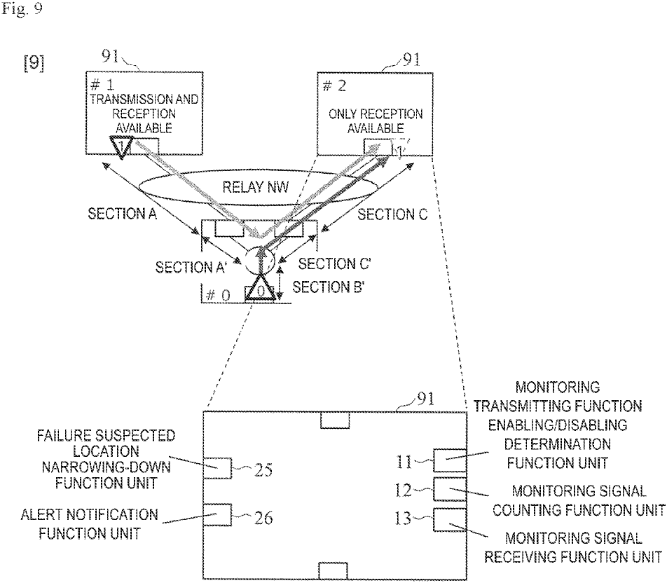

FIG. 9 illustrates an example of a system configuration according to the present embodiment. The system according to the present embodiment includes a failure isolation notification function. Specifically, the system according to the present embodiment includes three communication apparatuses. Connection is established between 91#1 and 91#0 and between 91#2 and 91#0, respectively. Here, it is not necessary for these apparatuses to be connected directly to each other.

The communication apparatus 91#1 includes functional units included in the first embodiment example, a functional unit that narrows down a failure suspected location from a combination of determination of reception/non-reception of the monitoring signal received from 91#2 and 91#0 and a link state (failure suspected location narrowing-down function unit 25) and a functional unit that provides a notification as an alert (alert notification function unit 26).

The communication apparatus 91#2 includes functional units included in the first embodiment example, a functional unit that narrows down the failure suspected location from a combination of determination of reception/non-reception of the monitoring signal received from 91#1 and 91#0 and a link state (failure suspected location narrowing-down function unit 25) and a functional unit that provides a notification as an alert (alert notification function unit 26).

The communication apparatus 91#0 has the functional units included in the first embodiment example.

A flow of signals according to the present embodiment will be described with reference to FIG. 9.

Step S401: The communication apparatus 91#2 sets an identifier of the functional unit that transmits and receives monitoring signals (the reference sign 14 illustrated in FIG. 4) to the same value as the monitoring identifier of the monitoring endpoint set in the communication apparatus 91#1 and disables the functional unit that transmits and receives monitoring signals.

Step S402: The communication apparatus 91#1 transmits, at an interval of N seconds, a multicast monitoring signal including an identifier (the identifier of the monitoring endpoint) set in advance in the functional unit that transmits and receives monitoring signals (the reference sign 14 illustrated in FIG. 4).

The communication apparatus 91#0 receives the multicast monitoring signal and transfers the multicast monitoring signal to the communication apparatus 91#2.

The communication apparatus 91#2 receives the multicast monitoring signal transmitted from the communication apparatus 91#1, the monitoring signal receiving function unit 13 extracts the multicast monitoring signal, the monitoring signal counting function unit 12 calculates an arrival time interval of the multicast monitoring signal, and determination of non-reception is made in a case in which the monitoring transmitting function enabling/disabling determination function unit 11 determines that the multicast monitoring signal has not been received M times straight at the interval of N seconds. The determination of reception is made in a case in which the multicast monitoring signal has been received M times straight at the interval of N seconds.

Step S403: The communication apparatus 91#0 transmits, at the interval of N seconds, the monitoring signal with the identifier (the identifier of the monitoring endpoint) set in advance in the functional unit that transmits and receives monitoring signals (the reference sign 14 illustrated in FIG. 4).

The communication apparatus 91#2 receives the monitoring signal transmitted from the communication apparatus 91#0, the monitoring signal receiving function unit 13 extracts the monitoring signal, the monitoring signal counting function unit 12 calculates an arrival time interval of the monitoring signal, and determination of non-reception is made in a case in which the monitoring transmitting function enabling/disabling determination function unit 11 determines that the multicast monitoring signal has not been received M times straight at the interval of N seconds. The determination of reception is made in a case in which the multicast monitoring signal has been received M times straight at the interval of N seconds.

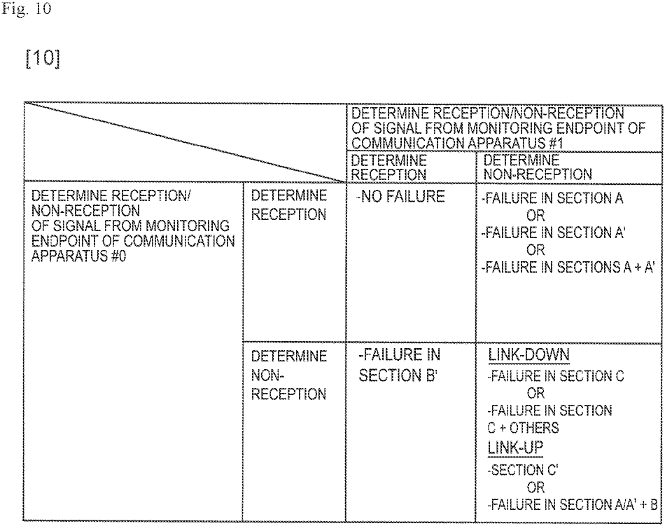

Step S404: The communication apparatus 91#2 determines presence or absence of a failure and a failure location based on, from each monitoring point, presence or absence of reception determination and a link state with reference to a table as illustrated in FIG. 10.

In a case in which the communication apparatus 91#2 makes determination of reception on the monitoring signal from the communication apparatus 91#1 and makes determination of reception on the monitoring signal from the communication apparatus 91#0, the communication apparatus 91#2 determines that no failure has occurred in the failure suspected location narrowing-down function unit 25 and provides a notification as an alert by the alert notification function unit 26. In a case in which the communication apparatus 91#2 makes determination of reception on the monitoring signal from the communication apparatus 91#1 and makes determination of non-reception on the monitoring signal from the communication apparatus 91#0, the communication apparatus 91#2 determines that a failure has occurred in a section B′ in the failure suspected location narrowing-down function unit 25 and provides a notification as an alert by the alert notification function unit 26.

In a case in which the communication apparatus 91#2 makes determination of non-reception on the monitoring signal from the communication apparatus 91#1 and makes determination of reception on the monitoring signal from the communication apparatus 91#0, the communication apparatus 91#2 determines that a failure has occurred in the section A, the section A′, or the sections A + A′ in the failure suspected location narrowing-down function unit and provides a notification as an alert by the alert notification function unit.

In a case in which the communication apparatus 91#2 makes determination of non-reception on the monitoring signal from the communication apparatus 91#1, makes determination of non-reception on the monitoring signal from the communication apparatus 91#0, and makes determination that a link state between the communication apparatus 91#2 and the communication apparatus 91#0 is down, the communication apparatus 91#2 determines that a failure has occurred in the section C or the section C + others in the failure suspected location narrowing-down function unit 25 and provides a notification as an alert by the alert notification function unit 26.

In a case in which the communication apparatus 91#2 makes determination of non-reception on the monitoring signal from the communication apparatus 91#1, makes determination of non-reception on the monitoring signal from the communication apparatus 91#0, and makes determination that the link state between the communication apparatus 91#2 and the communication apparatus 91#0 is up, the communication apparatus 91#2 determines that a failure has occurred in the section C′ or the sections A/A′ + B′ in the failure suspected location narrowing-down function unit 25 and provides a notification as an alert by the alert notification function unit 26.

Here, the link state indicates, for example, which of down and up the link state is. In a case in which light transmission and reception cannot be performed between physical interfaces of facing apparatuses, or in a case in which a light transmission and reception power has been lost and light seems not to physically arrive when seen from the facing interface, the communication apparatus 91#2 determines that the link state is down. On the other hand, in a case in which light transmission and reception can be performed without any problem between the physical interfaces of the facing apparatuses, the communication apparatus 91#2 determines that the link state is up.

The communication apparatus 91 according to the present disclosure can also be implemented by a computer and a program, and it is also possible to record the program in a recording medium or to provide the program through a network. For example, at least some of the monitoring transmitting function enabling/disabling determination function unit 11, the monitoring signal counting function unit 12, the monitoring signal receiving function unit 13, the functional unit 14, the transfer function unit 15, the waiting time holding function unit 21, the enabling/disabling waiting function unit 22, the client signal counting function unit 23, the client signal extracting function unit 24, the failure suspected location narrowing-down function unit 25, and the alert notification function unit 26 may be implemented by the computer executing the program.

### INDUSTRIAL APPLICABILITY

The present disclosure can be applied to information and communication industries.

### REFERENCE SIGNS LIST

11 Monitoring transmitting function enabling/disabling determination function unit
12 Monitoring signal counting function unit
13 Monitoring signal receiving function unit
14 Functional unit that transmits and receives monitoring signals
15 Transfer function unit
21 Waiting time holding function unit
22 Enabling/disabling waiting function unit
23 Client signal counting function unit
24 Client signal extracting function unit
25 Failure suspected location narrowing-down function unit
26 Alert notification function unit

1. A communication system where a plurality of communication apparatuses are connected to a zeroth communication apparatus and that is capable of switching a path connecting a first communication apparatus among the plurality of communication apparatuses and the zeroth communication apparatus and a path connecting a second communication apparatus among the plurality of communication apparatuses and the zeroth communication apparatus,
wherein the first communication apparatus periodically transmits a monitoring signal to the zeroth communication apparatus,
the zeroth communication apparatus transfers the monitoring signal from the first communication apparatus to the second communication apparatus,
the second communication apparatus enables transmitting a monitoring signal and starts to transmit the monitoring signal to the zeroth communication apparatus when the second communication apparatus does not receive the monitoring signal from the first communication apparatus continuously for a predefined number of times,
the zeroth communication apparatus transfers the monitoring signal from the second communication apparatus to the first communication apparatus, and
the first communication apparatus disables transmitting the monitoring signal when the first communication apparatus receives the monitoring signal from the second communication apparatus.

2. The communication system according to claim 1,
wherein the zeroth communication apparatus transfers the monitoring signal from the first communication apparatus to communication apparatuses other than the first communication apparatus among the plurality of communication apparatuses,
the communication apparatuses other than the first communication apparatus among the plurality of communication apparatuses include mutually different times to start transmitting monitoring signals to the zeroth communication apparatus when each of the communication apparatuses other than the first communication apparatus among the plurality of communication apparatuses does not receive the monitoring signal from the first communication apparatus continuously for a predefined period of time, and
each of the communication apparatuses other than the first communication apparatus among the plurality of communication apparatuses disables transmitting a monitoring signal when the each of the communication apparatuses other than the first communication apparatus among the plurality of communication apparatuses receives a monitoring signal from a communication apparatus of the communication apparatuses other than the first communication apparatus among the plurality of communication apparatuses that is different from the each of the communication apparatuses other than the first communication apparatus among the plurality of communication apparatuses before the each of the communication apparatuses other than the first communication apparatus among the plurality of communication apparatuses starts to transmit the monitoring signal to the zeroth communication apparatus.

3. The communication system according to claim 1,
wherein each of the plurality of communication apparatuses further extracts a client signal that is different from a monitoring signal and enables, when the each of the plurality of communication apparatuses receives the client signal continuously for a predefined number of times, transmitting a monitoring signal.

4. The communication system according to claim 1,
wherein each of the plurality of communication apparatuses uses a monitoring signal transmitted from a communication apparatus of the plurality of communication apparatuses that is different from the each of the plurality of communication apparatuses and a monitoring signal transmitted from the zeroth communication apparatus to narrow down a failure suspected location and provide a notification of a narrowed down failure location.

5. A communication path monitoring method executed by a communication system where a plurality of communication apparatuses are connected to a zeroth communication apparatus and that is capable of switching a path connecting a first communication apparatus among the plurality of communication apparatuses and the zeroth communication apparatus and a path connecting a second communication apparatus among the plurality of communication apparatuses and the zeroth communication apparatus, the method comprising:
by the first communication apparatus, periodically transmitting a monitoring signal to the zeroth communication apparatus;
by the zeroth communication apparatus, transferring the monitoring signal from the first communication apparatus to the second communication apparatus;
by the second communication apparatus, enabling transmitting a monitoring signal and starting to transmit the monitoring signal to the zeroth communication apparatus when the second communication apparatus does not receive the monitoring signal from the first communication apparatus continuously for a predefined number of times;
by the zeroth communication apparatus, transferring the monitoring signal from the second communication apparatus to the first communication apparatus; and
by the first communication apparatus, disabling transmitting the monitoring signal when the first communication apparatus receives the monitoring signal from the second communication apparatus.

6. A communication apparatus included in a communication system where a plurality of communication apparatuses are connected to a zeroth communication apparatus and that is capable of switching a path connecting a first communication apparatus among the plurality of communication apparatuses and the zeroth communication apparatus and a path connecting a second communication apparatus among the plurality of communication apparatuses and the zeroth communication apparatus,
wherein a monitoring signal is periodically transmitted to the zeroth communication apparatus, and
when a monitoring signal is received from the second communication apparatus, transmitting the monitoring signal is disabled.

7. (canceled)

8. A non-transitory computer-readable medium having computer-executable instructions that, upon execution of the instructions by a processor of a computer, cause the computer to function as the communication apparatus according to claim 6.
